(19) United States
(12) Patent Application Publication
(10) Pub. No.: US 2008/0283633 A1
(43) Pub. Date: Nov. 20, 2008

(54) Fuel Injection Valve

(75) Inventors: Hiroaki Nozaki, Higashimatsuyama-shi (JP); Eiji Hoshikawa, Higashimatsuyama-shi (JP)

Correspondence Address: CONNOLLY BOVE LODGE & HUTZ LLP, 1875 EYE STREET, N.W., SUITE 1100, WASHINGTON, DC, 20006, US

(73) Assignee: BOSCH CORPORATION, Tokyo (JP)

(21) Appl. No.: 10/571,775

(22) PCT Filed: Sep. 7, 2004
(86) PCT No.: PCT/JP2004/013280

§ 371 Date: Aug. 6, 2008

(30) Foreign Application Priority Data
Sep. 30, 2003 (JP) 2003-339447

(51) Int. Cl. F02M 51/06

(52) U.S. Cl. 239/585.5

(57) ABSTRACT

A fuel injection valve (1) configured such that control of the escape of high-pressure fuel inside a control chamber (45) to a fuel low-pressure portion is conducted by an electromagnetic valve (5) for controlling fuel injection configured such that a lift operation of an armature plate (51) is controlled by an electromagnetic solenoid (68) and an armature stopper (67) incorporated inside a fixed sleeve (61), wherein a gap (G3) is disposed between a fixed core (63) and the armature stopper (67), through holes (67B) are disposed in the armature stopper (67), and drain fuel flows to the fuel low-pressure portion via the gap (G3) and the through holes (67B) when the electromagnetic valve (5) is powered. As a result, the lift amount of the armature plate (51) can be prevented from changing as a result of debris or the like included in the drain fuel becoming caught between the armature plate (51) and the armature stopper (67).

### TECHNICAL FIELD

The present invention relates to a fuel injection valve that is disposed with an electromagnetic actuator and is for injecting/supplying fuel to the inside of a cylinder of an internal combustion engine.

### BACKGROUND ART

As a fuel injection valve for directly injecting/supplying fuel to the inside of a cylinder of an internal combustion engine such as employed in the Common Rail System, a fuel injection valve of the type disclosed in JP-A-7-310621, for example, is known. This fuel injection valve is configured such that an electromagnetic actuator is powered so that a control chamber inside an injection valve body becomes communicated with a fuel low-pressure portion, whereby the back pressure of a valve piston is removed, a nozzle needle is lifted, fuel injection is initiated, the powering of the electromagnetic actuator is stopped after the elapse of a predetermined amount of time, and the communicated state between the control chamber and the fuel low-pressure portion is released, whereby predetermined back pressure acts on the valve piston, the nozzle needle is pushed down, and fuel injection is terminated.

In the electromagnetic actuator for controlling fuel injection used in the fuel injection valve of the configuration described above, it is necessary for the lift amount of an armature plate that drives a valve element for controlling the communicated state between the control chamber and the fuel low-pressure portion in accordance with the switching ON and OFF of the power to be maintained at a constant. The reason for this is because when the lift amount of the armature plate changes, the lift amount (stroke amount) of the valve element also changes, which causes changes in the fuel injection amount, and the performance of the internal combustion engine changes, which therefore also causes an increase in noise and worsening of exhaust emissions.

Incidentally, this type of fuel injection valve is configured such that drain fuel from the control chamber enters a cylindrical armature stopper through an orifice and the armature plate surface and flows to a back rail.

Consequently, there is the potential for metal specks, microparticles, and other debris (referred to below simply as “debris or the like”) included in the drain fuel to become caught between the armature stopper and the armature plate surface and cause the lift amount of the armature to change. Further, there is the problem that when debris or the like becomes caught between the armature stopper and the armature plate surface, it becomes easy for friction between both parts to arise when the armature plate surface contacts the armature stopper, which causes large temporal changes in the lift amount of the armature stopper.

It is an object of the present invention to provide a fuel injection valve that can solve the aforementioned problem in the prior art.

It is another object of the present invention to provide a fuel injection valve that can be operated with the required characteristics over a long period of time.

It is still another object of the present invention to provide a fuel injection valve whose stable operation can be made reliable over a long period of time.

### DISCLOSURE OF THE INVENTION

According to the present invention, there is proposed a fuel injection valve disposed with an electromagnetic valve for controlling fuel injection configured such that an electromagnetic solenoid and a cylindrical armature stopper are coaxially incorporated inside a fixed sleeve and a lift operation of an armature plate is controlled by the electromagnetic solenoid and the armature stopper, with the fuel injection valve being configured such that fuel injection control is conducted as a result of the electromagnetic valve conducting control to allow high-pressure fuel inside a control chamber disposed inside an injection valve body to pass through the inside of the fixed sleeve and escape to a fuel low-pressure portion, wherein an escape passage is disposed for allowing drain fuel escaping from the control chamber to the fuel low-pressure portion to flow without passing through a gap between the armature stopper and the armature plate.

The invention may also be configured such that a through hole is disposed in a peripheral wall portion of the armature stopper, so that the drain fuel can pass through the through hole from the outer peripheral surface of the armature stopper, enter the armature stopper, and reach the fuel low-pressure portion.

Even if debris or the like is mixed into the drain mixed, the debris or the like can be effectively prevented from causing the lift amount of the armature plate to change, and the fuel injection valve can be stably operated. Further, friction between the armature plate and the armature stopper resulting from contact between both parts is reduced, stable operation can be made reliable over a long period of time, and the lifespan can be increased.

### BRIEF DESCRIPTION OF THE DRAWINGS

FIG. 1 is a cross-sectional view showing an embodiment of a fuel injection valve according to the present invention.

FIG. 2 is a cross-sectional view of an electromagnetic valve shown in FIG. 1.

### BEST MODE FOR IMPLEMENTING THE INVENTION

The present invention will now be described in greater detail in accordance with the attached drawings.

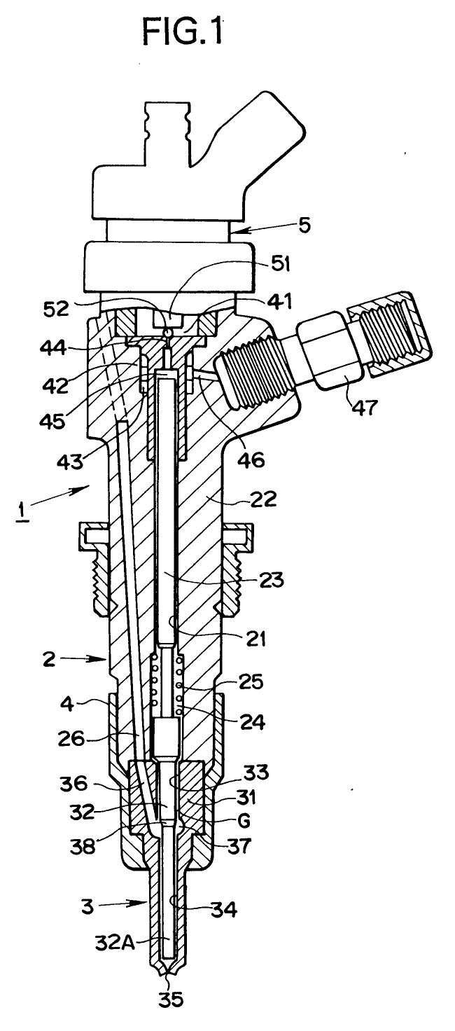

FIG. 1 is a cross-sectional view showing an example of an embodiment of a fuel injection valve according to the present invention. That which is represented by reference numeral 1 is a fuel injection valve used in the Common Rail System for injecting/supplying fuel to a diesel internal combustion engine. The fuel injection valve 1 is attached to a cylinder of an unillustrated diesel internal combustion engine, and is for directly injecting/supplying, to the inside of a cylinder and at a required timing, just the required amount of high-pressure fuel supplied from an unillustrated common rail. The fuel injection valve 1 includes a nozzle holder 2, a nozzle 3 is fixed to a leading end of the nozzle holder 2 with a retaining nut 4, and an electromagnetic valve 5 is disposed on a trailing end of the nozzle holder 2.

The nozzle holder 2 includes a hollow body 22 in which a guide hole 21 is formed in the axial direction of the hollow body 22, and a pressure pin 23 is disposed inside the guide hole 21 such that the pressure pin 23 is movable by the guide hole 21 in the axial direction of the guide hole 21. An elastic spring 25 is housed in a spring chamber 24 of the hollow body 22, and a later-described nozzle needle 32 is elastically urged by the elastic spring 25 in the direction of an injection hole 35. That which is represented by reference numeral 26 is a passage disposed inside the hollow body 22 in order to supply the high-pressure fuel from the unillustrated common rail to the nozzle 3.

The nozzle 3 includes a nozzle body 31 and the nozzle needle 32. The nozzle needle 32 is supported and guided, such that it is movable in its axial direction, by a guide hole 33 formed coaxially inside the nozzle body 31. A leading end portion 32A of the nozzle needle 32 extends inside a cylinder portion 34 disposed inside the nozzle body 31 in line with the guide hole 33, and the leading end of the nozzle needle 32 moves as a valve element that opens/closes the injection hole 35.

Consequently, when the nozzle needle 32 is retained in the position where it closes the injection hole 35, fuel is not injected from the fuel injection valve 1. In contrast, when the nozzle needle 32 withdraws and is retained in the position where it opens the injection hole 35, fuel is injected from the fuel injection valve 1.

An oil pool 37 for storing the high-pressure fuel introduced thereto from the passage 26 via a passage 36 is formed inside the nozzle body 31. A tapered portion 38 for causing force to act in a direction where the nozzle needle 32 is moved away from the injection hole 35 due to the pressure of the high-pressure fuel inside the oil pool 37 is formed on the nozzle needle 32.

A head 42, in which a drain chamber 41 extending coaxially with the guide hole 21 in the axial direction of the hollow body 22 is formed facing downward, is formed in a trailing end portion of the hollow body 22. A control chamber 45 that is communicated with a supply pathway 43 in the radial direction and a drain pathway 44 in the axial direction is formed in the head 42. The supply pathway 43 is communicated with an intake member 47 via a radial-direction pathway 46 inside the hollow body 22, and a bottom portion of the control chamber 45 is formed by an upper end surface of the pressure pin 23.

A ball 52 that works as a valve element configuring a valve mechanism that controls the communicated state between the control chamber 45 and a fuel low-pressure portion is fixed to an armature plate 51 of the electromagnetic valve 5. The armature plate 51 is configured such that it is elastically urged toward the drain pathway 44 by the force of an unillustrated valve spring, whereby the ball 52 is pushed against an open end of the drain pathway 44 to block off the drain pathway 44. However, when the electromagnetic valve 5 is urged, the armature plate 51 moves in the direction away from the head 42 counter to the force of the valve spring, whereby the ball 52 moves away from the open end of the drain pathway 44, and the drain pathway 44 becomes communicated with the drain chamber 41.

Consequently, when the electromagnetic valve 5 is not being powered, the open end of the drain pathway 44 is blocked off by the ball 52, whereby the control chamber 45 is filled with the high-pressure fuel. Thus, the nozzle needle 32 closes the injection hole 35 due to the pressure pin 23, and fuel injection is not conducted. When the electromagnetic valve 5 is powered, the ball 52 moves away from the open end of the drain pathway 44, the high-pressure fuel inside the control chamber 45 escapes to the fuel low-pressure portion, and the pressure inside the control chamber 45 drops, whereby fuel injection is conducted. When the power to the electromagnetic valve 5 is cut off, the nozzle needle 32 is again returned to the position where it closes the injection hole 35, and fuel injection ends.

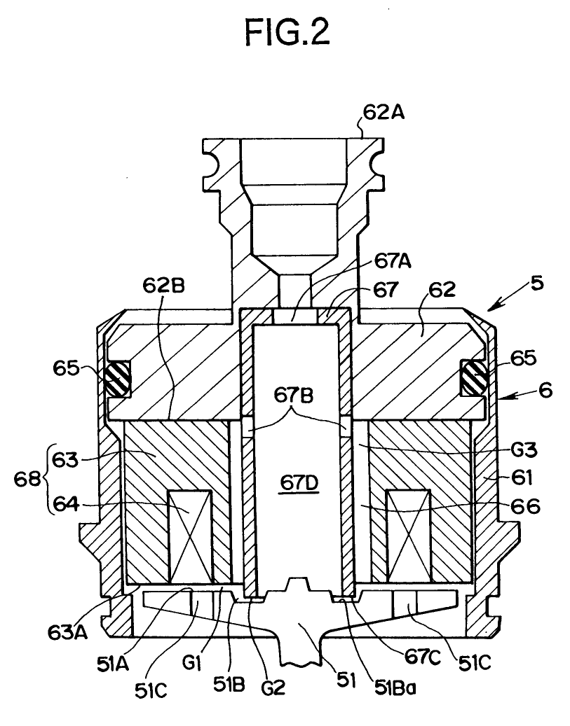

FIG. 2 is a cross-sectional view of the electromagnetic valve 5. The electromagnetic valve 5 is disposed with a magnet unit 6 that cooperates with the armature plate 51. The magnet unit 6 comprises a backflow tube 62 and a fixed core 63 disposed inside a fixed sleeve 61. An excitation coil 64 is disposed in the fixed core 63, whereby an electromagnetic solenoid 68 is configured which electromagnetically attracts the armature plate 51. An O-ring 65 is disposed between the fixed sleeve 61 and the backflow tube 62, and is configured such that fuel does not leak to the outside from between the fixed sleeve 61 and the backflow tube 62.

A drain attachment portion 62A connected to a fuel tank is integrally formed with the backflow tube 62, and the inside of the backflow tube 62 serves as the fuel low-pressure portion. An armature stopper 67 including a through hole 67A formed in one end is disposed inside a hole 66 in the axial direction of the fixed core 63. The armature stopper 67 is attached penetrating the fixed core 63 such that the through hole 67A and the drain attachment portion 62A become coaxial. In this manner, the backflow tube 62, the fixed core 63 and the armature stopper 67 are coaxially disposed inside the fixed sleeve 61.

The armature plate 51 comprises magnetic iron and is disposed facing the fixed core 63 inside the magnet unit 6. Additionally, the armature plate 51 is urged toward the head 42 by the unillustrated valve spring, and is configured such that the ball 52 is pushed against the open end of the drain pathway 44 to block off the drain pathway 44 (see FIG. 1).

The armature stopper 67 includes a stopper end 67C that extends further toward the armature plate 51 than a lower end portion 63A of the fixed core 63, and an annular groove 51B for receiving the stopper end 67C is formed in a main surface 51A of the armature plate 51.

When power is supplied to the electromagnetic solenoid 68, the armature plate 51 is attracted to the electromagnetic solenoid 68 until the stopper end 67C comes into contact with against a bottom surface 51Ba of the annular groove 51B, and the state where the stopper end 67C contacts the bottom surface 51Ba of the annular groove 51B is maintained. In this state of contact, the main surface 51A of the armature plate 51 faces the lower end surface 63A across a predetermined gap G1. At this time, virtually no fuel flows between the stopper end 67C and the bottom surface 51Ba, but fuel can flow into the gap G1.

Plural holes 51C for allowing drain fuel to pass therethrough are disposed in the armature plate 51, and when the ball 52 is separated from the opening of the drain pathway 44, the high-pressure fuel inside the control chamber 45 can pass through these holes 51C and enter the gap G1 as drain fuel.

In order to ensure that the drain fuel entering the gap G1 can enter a space 67D inside the armature stopper 67 without passing through a gap G2 between the stopper end 67C and the bottom surface 51Ba, an annular gap G3 is formed between the armature stopper 67 and the fixed core 63, and through holes 67B for allowing the gap G3 and the space 67D to be communicated are disposed in the armature stopper 67. In the example shown, two through holes 67B are disposed in the side wall portion bordering the gap G1, but the number of the through holes 67B can be an optional number of one or more.

As mentioned already, because the through hole 67A is formed in the portion of the armature stopper 67 bordering the fuel low-pressure side, the fuel inside the gap G3 enters the armature stopper 67 through the through holes 67B and flows to the fuel low-pressure side through the through hole 67A. In this manner, a flow path for guiding the fuel inside the gap G3 to the fuel low-pressure side is formed inside the armature stopper 67 by the through hole 67A and the through holes 67B.

Because the electromagnetic valve 5 is configured as described above, it operates in the following manner. When power is not being supplied to the electromagnetic solenoid 68, the armature plate 51 is spring-urged in the direction of the nozzle holder 2 by the unillustrated valve spring, and the ball 52 blocks off the drain pathway 44.

When power is supplied to the electromagnetic solenoid 68, the armature plate 51 is attracted by the electromagnetic solenoid 68 counter to the force of the valve spring. As a result, the stopper end 67C and the bottom surface 51Ba come into contact with each other, the ball 52 moves away from the opening of the drain pathway 44, and the high-pressure fuel inside the control chamber 45 is discharged to the inside of the electromagnetic valve 5 as drain fuel. Consequently, the gap G2 between the stopper end 67C and the bottom surface 51Ba becomes extremely narrow.

For this reason, virtually all of the drain fuel passes through the escape passages—i.e., the passages comprising the gaps G1 and G2 and the through holes 67B, and the space 67D inside the armature stopper 67 and the through hole 67A—and escapes to the fuel low-pressure side via the drain attachment portion 62A. Thus, the amount of drain fuel passing through the gap G2 and entering the space 67D is extremely small. Consequently, even if debris or the like is mixed in with the drain fuel, virtually none of the debris or the like remains inside the gap G2, and the armature stopper 67 can always maintain the rising position of the armature plate 51 at a predetermined position. Further, because debris or the like is extremely effectively prevented from entering the gap G2, abrasion of both members can be effectively prevented from becoming extreme as a result of the contact between the stopper end 67C and the bottom surface 51Ba.

As a result, even if debris or the like is mixed in with the drain fuel, the debris or the like can be effectively prevented from causing the lift amount of the armature plate to change, and the fuel injection valve can be stably operated. Further, because debris or the like can be prevented from entering the gap G2, abrasion of the armature plate and the armature stopper when both parts are in contact is reduced, stable operation can be made reliable over a long period of time, and the lifespan can be increased.

### INDUSTRIAL APPLICABILITY

According to the present invention, stable operation of an armature plate over a long period of time can be made reliable, which is useful for the improvement of a fuel injection valve.

1. A fuel injection valve disposed with an electromagnetic valve for controlling fuel injection configured such that an electromagnetic solenoid and a cylindrical armature stopper are coaxially incorporated inside a fixed sleeve and a lift operation of an armature plate is controlled by the electromagnetic solenoid and the armature stopper, with the fuel injection valve being configured such that fuel injection control is conducted as a result of the electromagnetic valve conducting control to allow high-pressure fuel inside a control chamber disposed inside an injection valve body to pass through the inside of the fixed sleeve and escape to a fuel low-pressure portion, wherein an escape passage is disposed for allowing drain fuel escaping from the control chamber to the fuel low-pressure portion to flow without passing through a gap between the armature stopper and the armature plate.

2. The fuel injection valve of claim 1, wherein the escape passage comprises
a first gap is formed between the armature plate and the electromagnetic solenoid when the armature plate contacts the armature stopper, and
a second gap that is formed between the electromagnetic solenoid and the armature stopper and is for causing the first gap to be communicated with the fuel low-pressure portion.

3. The fuel injection valve of claim 2, wherein an end portion of the armature stopper at the armature plate side is open, and an open end edge of the end portion contacts the armature plate.

4. The fuel injection valve of claim 3, wherein an annular groove is formed in the portion of the armature plate facing the open end edge, and the open end edge contacts a bottom surface of the annular groove.

5. The fuel injection valve of claim 3, wherein a flow path for guiding the fuel from the second gap to the fuel low-pressure portion is formed inside the armature stopper.

6. The fuel injection valve of claim 5, wherein the flow path is formed by a first through hole disposed in a wall portion of the armature stopper bordering the second gap and a second through hole disposed in a wall portion of the armature stopper bordering the fuel low-pressure side.
